(19) United States
(12) Patent Application Publication
(10) Pub. No.: US 2010/0313606 A1
(43) Pub. Date: Dec. 16, 2010

(54) METHOD FOR PRODUCING FIBERS FROM ROCKS AND A PLANT FOR CARRYING OUT SAID METHOD

(76) Inventors: Viktor F. Kibol, Kiev (UA); Roman V. Kibol, Kiev (UA)

Correspondence Address: LAW OFFICE OF DELIO & PETERSON, LLC., 121 WHITNEY AVENUE, NEW HAVEN, CT, 06510, US

(21) Appl. No.: 12/866,475

(22) PCT Filed: Apr. 29, 2008
(86) PCT No.: PCT/UA2008/000026

§ 371 Date: Aug. 6, 2010

(51) Int. Cl. C03B 37/02; C03B 37/03

(52) U.S. Cl. 65/475; 65/535

(57) ABSTRACT

The invention relates to a method and a plant for producing fibers from molten rocks such as basalt, diabase, amphibolite, andesite, dacite, granite and rhyolite. The inventive method involves rock crushing for producing grains of a specified size, charging the crushed rock into a melting zone and drawing fibers from the melt. The melting zone is extended along the vertical axis. The sized grains successively fall under gravity into the melting zone and the fibers are drawn from each sized grain melt. The drop rate of each sized grain into the melting zone is limited by the upward flow of a hot gas-air mixture. The plant comprises a rock crushing device and melting device with a melting zone whose outlet is connected to the discharge orifice with a bushing assembly and a device for fiber winding at the output. The plant includes a funnel at the outlet of the rock crushing device rotatable around the vertical axis.

### BACKGROUND OF THE INVENTION

1. Field of the Invention

The present inventions relate to methods and plants for the production of continuous fibers from melts of rock, such as in particular basalt, diabase, amphibolite, andesite, dacite, granite, rhyolite.

2. Description of Related Art

The present inventions are most useful in the production of continuous inorganic fibers of high-heat-resistant molten rock possessing low diathermacy, such as basalt, diabase, amphibolite, andesite, dacite, granite, rhyolite, and other rocks. These fibers may be applied in the production of hyperthermal woven and nonwoven fabric; knitted fabric, sewn, needle-punched, sew-knit products used as heat-and-sound-insulating and filtration materials; materials for composite and other products.

Improvement and development of the construction material industry in particular put forward a range of new demands, including further improvement of the manufacture technology of new materials of molten rock, with the reduction of applied equipment energy consumption and retention of produced materials high quality, which could help reduce the costs of production of such materials.

A method of producing continuous fibers of rocks is known comprising the operations of rock crushing, melting in a melting furnace and drawing of continuous fibers from the melt through a bushing /RF Patent 2102342, IPC6 C03B 37/00, publication date 20 Jan. 1998/. In the described method the rocks used are basalt group rocks, from basic to medium in contents, and the temperature in the furnace is within the range of 1500 to 1600° C. A drawback of the described method is significant energy consumption by the equipment applied, the melting furnaces in particular. Moreover, fibers produced with the use of this method have insufficient tensile strength due to presence of foreign inclusions whose melting temperature is above the melting temperature of the major portion of rock.

A method for producing fibers of rocks is known comprising the operations of rock melting and drawing of fibers from the melt through a bushing /Method for manufacturing mineral fibers, U.S. Pat. No. 6,125,660 Oct. 3, 2000/.

Drawbacks of the method are significant energy consumption and low temperature in the furnace (1480° C.) which prevents in particular phenocrysts whose melting temperature is above 1480° C. from melting and leads to fiber drawing process instability due to crystallization in bushings. Fibers produced with the use of the proposed method have insufficient tensile strength and thermal stability.

The most similar to the proposed method in terms of a number of essential features is a method of continuous fiber production from rock comprising the operations of rock crushing to make grains of specific size, charging crushed rock into the melting zone and drawing fibers from the melt /International publication number WO 2005/00991 1 of Mar. 2, 2005; International Application Number PCT/CZ2004/000039 of 21 Jul. 2004/.

According to the described method, rock is crushed to form grains 2 to 15 mm in size that are charged to the melting chamber heated with the radiation frequency of 2450 MHz where the grains form a melt. From there the melt outflows to a 2450 MHz radiation heated superheating chamber with an outlet. The melt is directed through the outlet into a fiberizing tank. The outlet of the fiberizing tank can consist of a set of nozzles for drawing the continuous mineral or glass fibers. As the process involves not only the heating of grains and melt but also the structural elements the described method is quite energy-intensive, which results in increased production cost of fibers and quite bulky equipment. Moreover, the quality of fibers—their strength in particular—is not sufficient due to a significant thermal gradient along the vertical extent of the melt in the superheating chamber.

The most similar to the proposed device in terms of technical characteristics and obtained results is that for the production of continuous fibers of rock comprising a rock crushing device and melting device with a melting zone, whose outlet is connected to a discharge orifice with a bushing assembly and a device for fiber winding at the output [RF Patent No. 021 18300, IPC 6 C 03B 37/02, 1998]. The described plant comprises a melting furnace connected to a feeder, discharge orifice connected to the feeder, and a heated bushing assembly situated below the discharge orifice. Moreover, it comprises a batch container for basalt charging, heat exchanger connected to the combustion space of the melting furnace. The melting furnace is equipped with a stabilizer where molten glass is stabilized by volume to the fiber working point. The melting furnace and stabilizer are equipped with heater systems. The melting furnace stabilizer is connected to the feeder where a melt is homogenized and proper composition controlled. The feeder is equipped with drain valves and flow devices to deliver the melt to bushings. Continuous basalt filaments are drawn through the latter, passed through a sizing device and wound on bobbins.

Drawbacks of the described plant are significant energy consumption by the melting furnace and elements the melt pass on the way to the discharge orifice, and large dimensions.

### SUMMARY OF THE INVENTION

Bearing in mind the problems and deficiencies of the prior art, it is therefore an object of the present invention to provide a plant for the production of fibers of rock.

It is another object of the present invention to provide a method for producing fibers from rock.

The present invention aims at the applied equipment downsizing and energy consumption reduction. The objective is attained by creating conditions for the successive melting of each sized grain and delivery of the melt formed of each grain to the discharge orifice.

The objective is attained by the proposed method comprising—similar to the known method of the production of continuous fibers of rock—the operations of rock crushing to form grains of specified size, crushed rock charging to the melting zone and fiber drawing from the melt. According to the invention, grains of specified size are formed in the process of rock crushing, successively charged under gravity into the melting zone, and fibers are drawn from the melt of each sized grain. A distinctive feature of the proposed method also consists in that each grain is supported by heated air-gas flow in the process of charging into the melting zone. Still other objects and advantages of the invention will in part be obvious and will in part be apparent from the specification.

A distinctive feature of the proposed method also consists in that in the process of crushing of rock containing not less than 62 wt. % of silicon oxide sized grains are produced whose typical size ranges 1.6 to 2.1 mm.

A distinctive feature of the proposed method also consists in that in the process of crushing of rock containing not less than 62 wt. % of silicon oxide sized grains are produced whose typical size ranges 1.6 to 2.1 mm.

The objective is also attained in the proposed plant comprising—similar to the known plant for the production of continuous fibers of rock by means of the described method—a rock crushing device and melting device with a melting zone whose outlet is connected to the discharge orifice with a bushing assembly and a device for fiber winding at the output. According to the invention, the plant is equipped with a batch container in the form of a funnel at the outlet of the rock crushing device installed so that it can rotate around the vertical axis. The inner conical surface of the funnel is intended for receiving crushed rock, and the central through-hole of the funnel is intended for the passing of sized grains of crushed rock to the melting zone.

A distinctive feature of the proposed plant also consists in that it is equipped with a compressor, with a gas burner and nozzle directed toward the melting zone at its output.

The above and other objects, which will be apparent to those skilled in the art, are achieved in the present invention which is directed to a method of fiber production from rock. The method includes crushing rock to form grains of a specified size and charging crushed rock into a melting zone along a vertical axis wherein sized grains successively fall into the melting zone under gravity. The method includes drawing fibers from the melt of each sized grain.

The grain drop rate into the melting zone may be controlled by the ascending flow of hot gas-air mixture. The process may include andesite rock crushing wherein sized grains are produced having a typical size range between 2.8 mm and 3.6 mm. The process may include rock containing not less than 62 wt. % of silicon oxide with sized grains produced having typical size ranges from about 1.6 mm to about 2.1 mm.

In another aspect, the present invention is directed to a plant for the production of fibers from rock by the method described above. The plant includes a rock crushing device and a batch container in the form of a funnel at an outlet of the rock crushing device, the batch container rotatable around a vertical axis. The funnel includes an inner conical surface intended for receiving crushed rock and a central through-hole intended for the passing of sized grains of crushed rock to the melting zone. The plant includes a melting device with a melting zone outlet connected to a discharge orifice having a bushing assembly. The plant additionally includes a device for winding fiber as the fiber is discharged from the discharge orifice.

The plant may include a compressor and a gas burner with nozzles directed toward the melting zone wherein a flow of a gas-air mixture is generated reducing the flow of grains falling into the melting zone.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of the plant for the production of fibers of rock according to the present invention.

### DESCRIPTION OF THE PREFERRED EMBODIMENT(S)

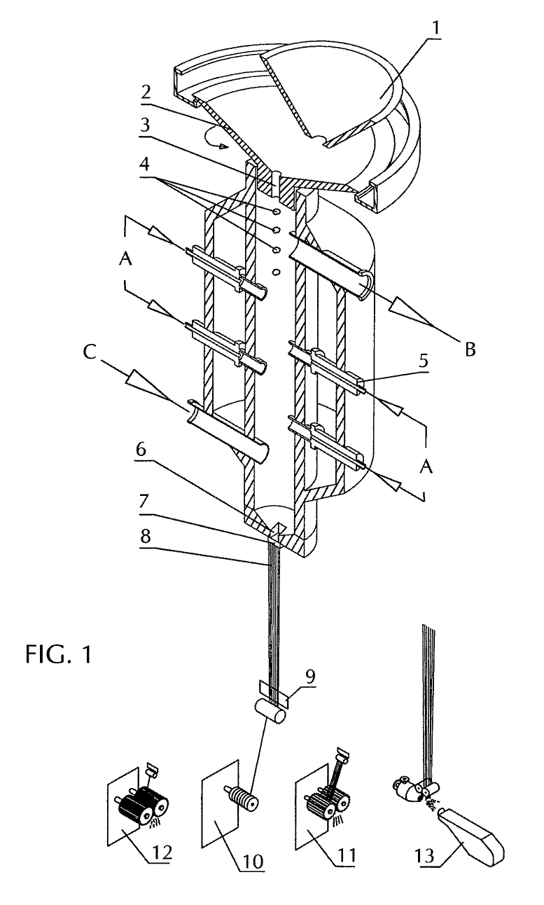

In describing the preferred embodiment of the present invention, reference will be made herein to FIG. 1 of the drawings.

The proposed inventions are aimed at significant reduction of energy consumption due to successive melting of each sized grain and delivery of melt formed by each grain to the discharge orifice. Furthermore, grains whose size is smaller than the specified size (below 2.8 mm for andesite rock grains, and for grains of rock containing not less than 62 wt. % of silicon oxide below 1.6 mm) are blown off the conical surface of the funnel by the air current resulting from the funnel rotation with grains, and those whose size is above the specified one (above 3.6 mm and 2.1 mm respectively) passing through the funnel due to the centrifugal force in the same. Moreover, the gas-air mixture surrounding sized grains passing through the funnel under gravity is a good heat-insulating material, thus heat loss is negligible. The time needed to melt a grain during its fall is determined by its drop height—the distance between the funnel outlet and discharge orifice—and the rate of heat flow. Due to the absence of a furnace and other heat-intensive elements in the plant, and the utilization of air and gas-air mixture as heat insulation the proposed method and plant allow to significantly reduce the process energy consumption and to produce quality fibers of rock.

The proposed plant—Module Kibol-Granula—for the production of fibers of rock is schematically presented in the drawing attached. The Module Kibol-Granula plant contains a rock crushing device (not shown). The rock crushing device outlet is connected to the bunker 1. A gate valve (not shown) is installed in the bunker 1 outlet. A batch container is installed at the bunker 1 outlet. The batch container is in the form of a funnel 2 equipped with a motor for its rotation around the vertical axis with a given angular velocity, and a rotation velocity sensor (not shown). The inner conical surface of the funnel 2 is intended to receive crushed rock, and the central through-hole 3 of the funnel is intended to pass sized grains 4 of crushed rock to the melting zone. The funnel 2 zone with the axial hole 3 is detachable to ensure the required hole 3 diameter. The plant is equipped with a heating element. The heating element 5 is constructed in the form of a row of successive gas burners installed along the funnel 2 axis—along the grain 4 drop pathway. Gas burner nozzles of the heating element 5 are directed toward the funnel 2 axis—the grain 4 drop pathway—and form the melting zone for the same. There is a discharge orifice 6 in the lower part of the plant. A bushing assembly 7 is installed in the discharge orifice 6 intended for drawing raw fibers 8 through the same, their sizing by means of a sizing device 9 and subsequent winding on a winding device 10 for continuous fibers, device 11 for coarse fibers, device 12 for chopped fibers, device 13 for staple fibers. The plant is equipped with a compressor (not shown) intended for the vertical pumping of an air or oxygen mixture for natural gas combustion or slowdown of the grain 4 drop, as well as raw fiber 8 blowing into staple fibers at device 13 by a flow of hot gases.

To adjust and reduce the grain drop rate a disc-shaped nozzle is used with a central grain passage and through-holes located uniformly and forming a circle whose axes concur on the funnel 3 axis at a distance of 25 to 30 mm from the output area of grains intended for the pumping of gas-air mixture through the same. The plant can have 3 or 4 such discs (not shown). Apart from the specified elements the plant comprises grain temperature detection and recording device connected with appropriate temperature transmitters, a funnel 3 rotation velocity recording device, produced fiber thickness recording device and control system (not shown). The control system comprises pyrometric temperature transmitters installed at three spots along the grain drop height 5 (not shown). The pyrometric temperature transmitter outputs are connected to a thyristor temperature control (not shown). The plant is also equipped with a thyristor control for the funnel 3 motor shaft rotation velocity (not shown).

The authors have experimentally determined the optimum size of grains and operating conditions. Thus, in the process of andesite rock crushing grains are formed whose typical size ranges from 2.8 to 3.6 mm, and in the process of crushing rock containing not less than 62 wt. % of silicon oxide grains are formed whose typical size ranges from 1.6 to 2.1 mm. Such sizes of grains allow the use of a plant with the dimensions not exceeding 2.2×1.5×1.5 m preserving high quality of produced fibers. Larger grains would result in increased plant dimensions. Grains smaller than the optimum size result in a significantly longer process for a required volume of fibers.

The proposed plant operation is as follows. The prepared materials—grains—are charged into the bunker 1 and fall on the conical surface of the rotating funnel 2 through the bunker 1 output. The grain drop rate is determined by the bunker 1 output diameter and pressure dependent on a material volume in the bunker 1. On the conical surface of the funnel 2, grains that are smaller in size than the specified range are light and thus blown off the conical surface of the funnel by a gas flow, and grains that are bigger in size than the specified range are passed through the funnel 2 due to the centrifugal force in the same. The discharge rate of the rotating funnel 2 outlet is determined by the funnel 2 rotation velocity, its taper angle and grain weight. Optimum geometrical parameters of the funnel 2 and its outlet 3 are determined experimentally. Through the through-hole optimum size grains 4 are charged into the melting zone where they are subjected to the heat from the gas burners of the heating element 5. The grain 4 drop rate is reduced by means of the ascending flow of hot flue gases and air from the compressor, which allows converting grains 4 into rock micromelts in the discharge orifice zone 6. The discharge orifice zone 8 with the bushing assembly 7 preheated by the heating element (not shown) allows to maintain the required melt temperature before fibers are drawn, sized and wound onto a bobbin of device 10 for continuous fibers, device 11 for coarse fibers, device 12 for chopped fibers and device 13 for staple fibers.

### Example 1

Fibers were produced of andesite rock. Preliminary, the material was crushed to form grains whose typical size ranged from 1.8 to 4.2 mm. In the batch container optimum geometrical parameters of grains 4 were defined. For that purpose, the funnel 2 rotation velocity and its taper angle were determined. Furthermore, the funnel 2 rotation velocity, its taper angle and central through-hole 3 diameter of the funnel 2 were defined to control the passage through the batch container of grains 4 whose typical size was within the range of 2.8 to 3.6 mm.

Fiber drawing from each grain 4 melt was carried out at 1150-1290° C. Fibers were produced in the plant as described above. As a result, andesite rock with the chemical composition shown in Table 1 resulted in continuous fibers whose properties are described in Table 2.

TABLE 1

| Oxides | SiO₂ | TiO₂ | Al₂O₃ | Fe₂O₃ + FeO | CaO | MgO | Na₂O | K₂O | MnO | P₂O₅ |
|---|---|---|---|---|---|---|---|---|---|---|
| Average | 57.6 | 0.96 | 17.4 | 8.95 | 6.56 | 2.30 | 2.56 | 2.67 | 0.21 | 0.20 |
| concentration, | | | | | | | | | | |
| wt % | | | | | | | | | | |

The strength of continuous filaments was determined by means of a force balance, with the gage length of 10 mm, while that of coarse fibers with a tensile testing machine RM-3, with the gage length of 50 mm.

TABLE 2

| | Filament | | | | | |
|---|---|---|---|---|---|---|
| | mean | | | | | |
| | diameter, | Tensile strength, MPa, at the grain diameter | | | | |
| Rock type | μm | 1.8 mm | 2.0 mm | 2.9 mm | 3.6 mm | 4.0 mm |
| Andesite | 8.6-9.8 | 1900 | 1998 | 2100 | 2095 | 1960 |
| (Table 1) | | | | | | |

| | | |
|---|---|---|
| Prototype | 8.9-10.2 | 1800 |

Coarse fibers were produced from homogenized melt formed by melting each grain individually. Moreover, filaments were formed by a 600-nozzle bushing assembly of a refractory alloy. Filaments were drawn mechanically at the rate of 5-10 m/min. The resulting coarse fibers were cut to pieces at device 11. Table 3 shows the main properties of the coarse fibers.

TABLE 3

| | | Mean diameter grain |
|---|---|---|
| Rock type | Diameter, μm | tensile strength, kg/mm² |
| Andesite (Table 1) | 154.8 | 23.8 |
| Prototype | 155.6 | 22.2 |

Chopped fibers of highly homogenized andesite melt were produced by means of a 4000-nozzle bushing. From there continuous fibers were delivered to chopping machine 13. Table 4 shows the main properties of the chopped fibers.

TABLE 4

| | | Fiber | Not chopped fibers |
|---|---|---|---|
| Parameter | Length, mm | diameter, μm | not exceeding, % |
| Andesite (Table 1) | 5.9 | 10.1 | 2.9 |
| Prototype | 6.2 | 11.0 | 3.6 |

Staple fibers were produced from andesite melts by blowing raw fibers with the hot gas flow by means of the known method (see Kitaygorodsky N. I. Glass Technology. M: Gosstroyizdat, 1961. 624 p). Table 5 shows the main properties of the staple fibers.

TABLE 5

Chemical resistance, %

| | Diameter, | | 0.5 N | 2.0 N | 2 N |
|---|---|---|---|---|---|
| Deposit | μm | H₂O | NaOH | NaOH | HCL |
| Andesite | 0.78 | 94.6 | 82.9 | 78.9 | 80.3 |
| (Table 1) | | | | | |
| Prototype | 0.71 | 93.9 | 81.3 | 75.7 | 77.4 |

Continuous, coarse, chopped and staple fibers produced by the described method in the Module Kibol-Granula plant outperform fibers produced in the prototype process, with significant energy consumption reduction due to absence of a furnace and other heat-intensive elements in the plant, and application of air and gas-air mixture as insulation.

### Example 2

Continuous fibers were produced of rock containing not less than 62 wt. % of silicon oxide. The rock chemical composition is shown in Table 6. Sized grains were formed whose typical size ranges from 1.6 to 2.1 mm. Preliminary the material was crushed to form grains whose typical size ranged from 1.0 to 3.0 mm. In the batch container optimum geometrical parameters of grains 4 were defined. Furthermore, the funnel 2 rotation velocity, its taper angle and central through-hole 3 diameter of the funnel 2 were defined to control the passage through the batch container of grains 4 whose typical size was within the range of 1.6 to 2.1 mm.

Fiber drawing from each grain 4 melt was carried out at 1300-1450 C. Fibers were produced in the plant as described above.

TABLE 6

| Oxides | SiO₂ | TiO₂ | Al₂O₃ | Fe₂O₃ + FeO | CaO | MgO | Na₂O | K₂O | MnO | P₂O₅ |
|---|---|---|---|---|---|---|---|---|---|---|
| Average | 67.3 | 0.41 | 15.2 | 4.6 | 3.59 | 1.08 | 2.92 | 2.86 | 0.1 | 0.12 |
| concentration, | | | | | | | | | | |
| wt % | | | | | | | | | | |

Table 7 shows the main properties of the fibers.

TABLE 7

| | Filament | | | | | |
|---|---|---|---|---|---|---|
| | mean | | | | | |
| | diameter, | Tensile strength, MPa, at the grain diameter | | | | |
| Rock type | μm | 1.5 mm | 1.4 mm | 1.7 mm | 2.0 mm | 2.2 mm |
| Dacite | 8.3-9.9 | 2301 | 2389 | 2498 | 2480 | 2300 |
| (Table 1) | | | | | | |

| | | |
|---|---|---|
| Prototype | 8.9-10.2 | 1800 |

The produced fibers may be used for heat and sound insulation of different facilities, for replacement of carcinogenic asbestos products in most industries.

The proposed inventions result in reduction of the applied equipment dimensions and fiber process energy consumption due to conditions for melting of each sized grain 4 and delivery of melt from each grain 4 to the discharge orifice 6.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1-6. (canceled)

7. A method of fiber production from rock comprising:
crushing rock to form grains of a specified size;
charging crushed rock into a melting zone along a vertical axis wherein sized grains successively fall into the melting zone under gravity; and
drawing fibers from the melt of each sized grain.

8. A method of production of fibers from rock as defined in claim 7 wherein the grain drop rate into the melting zone is controlled by the ascending flow of a hot gas-air mixture.

9. A method of production of fiber from rock as defined in claim 7 wherein andesite rock is crushed to produce sized grains having a size range from 2.8 mm to 3.6 mm.

10. A method of production of fibers from rock as defined in claim 7 wherein the rock contains not less than 62 wt. % of silicon oxide and sized grains are produced having a size range from 1.6 mm to 2.1 mm.

11. A plant for the production of fibers from rock by the method described in claim 7 comprising:
a rock crushing device;
a batch container in the form of a funnel at an outlet of the rock crushing device rotatable around a vertical axis, the funnel including an inner conical surface intended for receiving crushed rock and a central through-hole intended for the passing of sized grains of crushed rock to the melting zone;
a melting device with a melting zone outlet connected to a discharge orifice having a bushing assembly; and
a device for winding fiber as the fiber is discharged from the discharge orifice.

12. A plant for the production of fibers from rock by the method described in claim 8 comprising:
a rock crushing device;
a batch container in the form of a funnel at an outlet of the rock crushing device rotatable around a vertical axis, the funnel including an inner conical surface intended for receiving crushed rock and a central through-hole intended for the passing of sized grains of crushed rock to the melting zone;
a melting device with a melting zone outlet connected to a discharge orifice having a bushing assembly; and
a device for winding fiber as the fiber is discharged from the discharge orifice.

13. A plant for the production of fibers from rock by the method described in claim 9 comprising:
a rock crushing device;
a batch container in the form of a funnel at an outlet of the rock crushing device rotatable around a vertical axis, the funnel including an inner conical surface intended for receiving crushed rock and a central through-hole intended for the passing of sized grains of crushed rock to the melting zone;
a melting device with a melting zone outlet connected to a discharge orifice having a bushing assembly; and
a device for winding fiber as the fiber is discharged from the discharge orifice.

14. A plant for the production of fibers from rock by the method described in claim 10 comprising:
a rock crushing device;
a batch container in the form of a funnel at an outlet of the rock crushing device rotatable around a vertical axis, the funnel including an inner conical surface intended for receiving crushed rock and a central through-hole intended for the passing of sized grains of crushed rock to the melting zone;
a melting device with a melting zone outlet connected to a discharge orifice having a bushing assembly; and
a device for winding fiber as the fiber is discharged from the discharge orifice.

15. A plant as in claim 11, including a compressor and a gas burner with nozzles directed toward the melting zone wherein a flow of a gas-air mixture is generated reducing the flow of grains falling into the melting zone.

16. A plant as in claim 12, including a compressor and a gas burner with nozzles directed toward the melting zone wherein a flow of a gas-air mixture is generated reducing the flow of grains falling into the melting zone.

17. A plant as in claim 13, including a compressor and a gas burner with nozzles directed toward the melting zone wherein a flow of a gas-air mixture is generated reducing the flow of grains falling into the melting zone.

18. A plant as in claim 14, including a compressor and a gas burner with nozzles directed toward the melting zone wherein a flow of a gas-air mixture is generated reducing the flow of grains falling into the melting zone.
